(19) United States
(12) Patent Application Publication
(10) Pub. No.: US 2004/0205064 A1
(43) Pub. Date: Oct. 14, 2004

(54) Adaptive search employing entropy based quantitative information measurement

(76) Inventors: Nianjun Zhou, Somers, NY (US); Dikran S. Meliksetian, Danbury, CT (US); Chen Shu, Oakville, CT (US)

Correspondence Address: John E. Campbell, IBM Corporation, 2455 South Road, P386, Poughkeepsie, NY, 12601, US

(21) Appl. No.: 10/412,934

(22) Filed: Apr. 11, 2003

(51) Int. Cl. G06F 17/30; G06F 7/00

(52) U.S. Cl. 707/5

(57) ABSTRACT

An entropy based adaptive search method for searching a database or other repository system or modality whereby an Attribute of an object is presented as a question to a user. The Attributes are presented according to their adjusted entropy values. The user provides an attribute value to the attribute by the act of selecting one question from the questionnaire to begin with. Each time the user selects a question and answers it, a new list of attributes and a new questionnaire is derived based on previous activity. When a threshold number of results has been reached the results are displayed to the user.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### FIELD OF THE INVENTION

The present invention is related to systems and methods for computer based searching of data records, more particularly adaptive search of data repositories including relational databases, hierarchical databases, LDAP, URL, or web forums.

### BACKGROUND OF THE INVENTION

The International Business Machines (“IBM”) Software Glossary defines a “schema” as “The set of statements, expressed in a data definition language, that completely describe the structure of a database.” (This Software Glossary is located on the World Wide Web at www.networking.ibm.com/nsg.) These statements provide a logical view of the database structure, including the layout format of the database records as well as relationship information. The layout information includes which fields appear in each record, the data type for each field (such as whether it is numeric, binary, character, image, etc.). Relationship information specifies how various fields are related within the database. For example, for data that has a hierarchical structure, parent and child relationships will be described in the schema.

With the explosion of the use of the Internet and particularly wireless networks, a need exists for both enterprises and individual consumers to have access to information from a variety of devices such as web browsers and pervasive devices such as phones or PDAs. Compared to standard web applications, applications targeted for pervasive devices usually utilize narrow communication bandwidth and small screen size or serialized input (such as voice). The usability of such applications largely depends on the efficiency of information exchange.

Repositories that may be searched include a wider variety of data storage mechanisms including, but not limited to: relational databases, hierarchical databases, LDAP, URL, or web forums.

Conventional computerized search systems do not provide maximum efficiency due, for example, to the following limitations:

No feedback between user and server;

Server assumes the users know all the searchable attributes equally well;

Search is the same for all users; and

Knowledge of prior usage of the search is not utilized by the server.

### SUMMARY OF THE INVENTION

The present invention relates to the field of information measurement of attributes in an information system. It describes the design of an intelligent search system with significant usage of the system information and input information to reduce the cost of search. This invention utilizes the entropy values and the inputs from end-users to determine the most efficient searchable attribute with which to search the system. The methodology of the present invention can be used for a wide variety of search system with a wide variety of possible search input mechanisms. Adaptive web search systems; voice-based adaptive search systems; PDA-based adaptive search system and text-based adaptive search for instant messaging program robots (bots) are example embodiments utilizing the present invention. A “bot” is an intelligent software agent that responds to the end-user for certain business applications. It is a program equivalent to a Robot.

It is therefore an object of the present invention to provide a repository search facility that is adaptive wherein the search adapts based on entropy. It is a further object of the invention to provide an adaptive search facility that is accessible by way of a wide variety of media.

It is a further object of the invention to prompt the user with an adaptive prompt for suggesting weighted search criteria, the adaptive prompt providing adaptive search criteria based on previously entered search attributes.

It is a further object of the invention to indicate to the user, the quantity of results of an adaptive search in order for the user to determine whether further limitations would be useful before performing the search.

It is a further object of the invention to employ a initial searchability value to the search attribute based on knowledge of system accumulated from previous usage of the system and re-compute the searchability when a search is finished.

It is a further object of the invention to complete the search if the attributes selected result in search results less than a predetermined number.

It is a further object of the invention to use a predetermined entropy value if the number of results from a search exceeds a predetermined value.

The above as well as additional objectives, features, and advantages of the present invention will become apparent in the following drawings and written description.

### BRIEF DESCRIPTION OF THE DRAWINGS

FIG. 1 is a diagram depicting a computer system;

FIG. 2 is a diagram depicting a computer network;

FIG. 3 is a flowchart representing user prompts;

FIG. 4 is a flowchart of a deduced system generation;

FIG. 5 is a flowchart of web based interaction;

FIG. 6 is a flowchart of a bot based interaction;

FIG. 7 is a flowchart of a phone based interaction;

FIG. 8 is an example system diagram for interacting with various media;

FIG. 9A-9C is a flow of events in an example interaction; and

FIG. 10 is a flow depicting a PDA implementation.

### DESCRIPTION OF THE PREFERRED EMBODIMENT

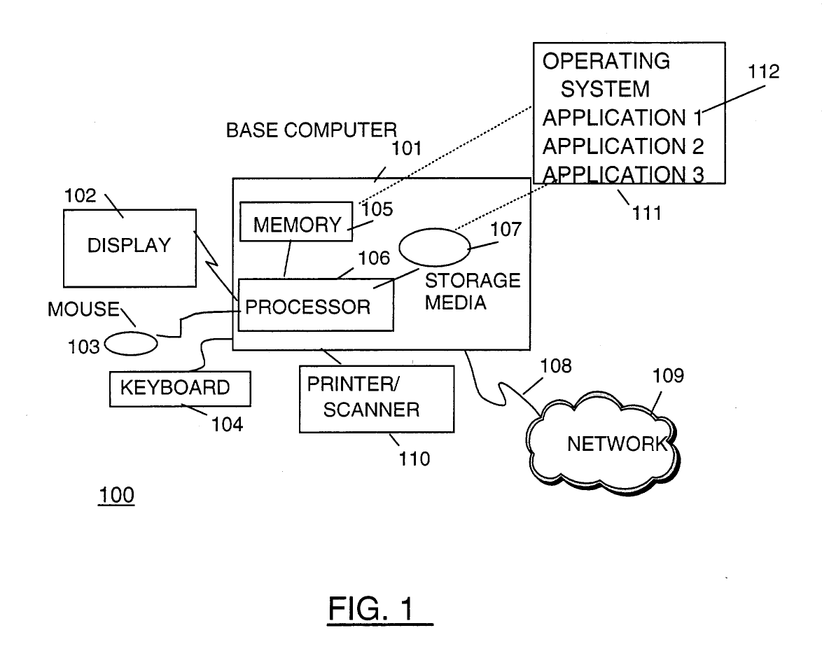

FIG. 1 illustrates a representative workstation hardware system in which the present invention may be practiced. The system 100 of FIG. 1 comprises a representative single user computer workstation 101, such as a personal computer, including related peripheral devices. The workstation 101 includes a microprocessor 106 and a bus employed to connect and enable communication between the microprocessor 106 and the components of the workstation 101 in accordance with known techniques. The workstation 101 typically includes a user interface adapter, which connects the microprocessor 106 via the bus to one or more interface devices, such as a keyboard 104, mouse 103, a Printer/scanner 110 and/or other interface devices, which can be any user interface device, such as a touch sensitive screen, digitized entry pad, etc. The bus also connects a display device 102, such as an LCD screen or monitor, to the microprocessor 106 via a display adapter. The bus also connects the microprocessor 106 to memory 105 and long-term storage 107 which can include a hard drive, diskette drive, tape drive, etc.

The workstation 101 may communicate with other computers or networks of computers by way of a network adapter capable of communicating with a network 109. Example network adapters are communications channels, token ring, ethernet or modems. Alternatively, the workstation 101 may communicate using a wireless interface, such as a CDPD (cellular digital packet data) card. The workstation 101 may be associated with such other computers in a local area network (LAN) or a wide area network (WAN), or the workstation 101 can be a client in a client/server arrangement with another computer, etc. All of these configurations, as well as the appropriate communications hardware and software, are known in the art.

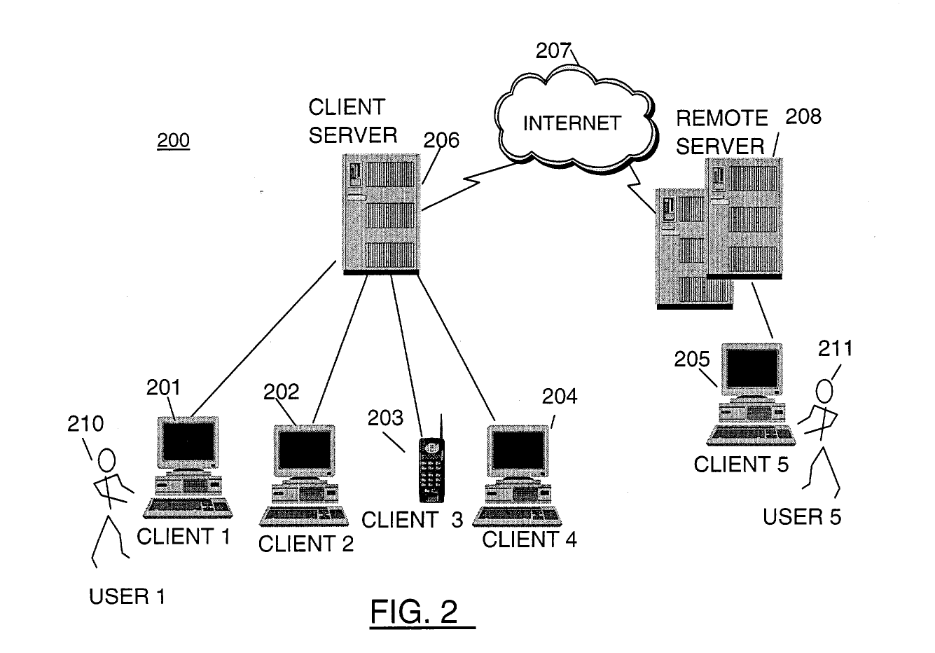

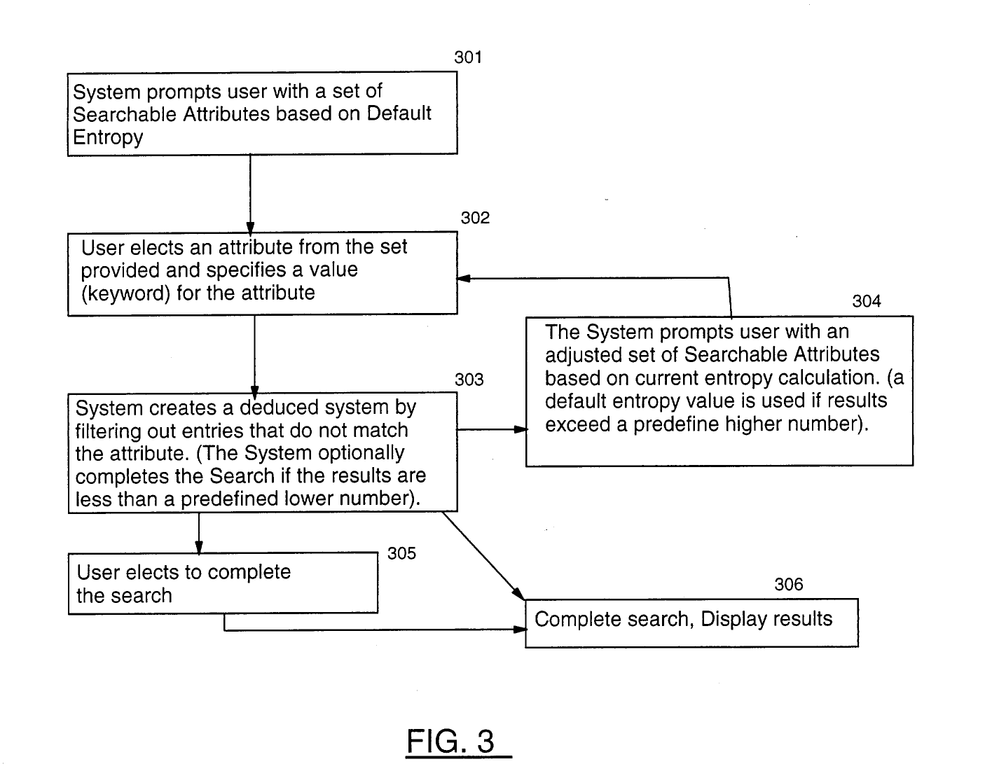

FIG. 2 illustrates a data processing network 200 in which the present invention may be practiced. The data processing network 200 may include a plurality of individual networks, such as wireless network and a wire network, each of which may include a plurality of individual workstations 101. Additionally, as those skilled in the art will appreciate, one or more LANs may be included, where a LAN preferably supports a plurality of intelligent workstations coupled to a host processor.

Still referring to FIG. 2, the networks may also include mainframe computers or servers, such as a gateway computer (client server 206) or application server (remote server 208 which may access a data repository). A gateway computer 206 serves as a point of entry into each network 207. A gateway is needed when connecting one networking protocol to another. The gateway 206 may be preferably coupled to another network (the Internet 207 for example) by means of a communications link. The gateway 206 may also be directly coupled to one or more workstations 101 using a communications link. The gateway computer may be implemented utilizing an Enterprise Systems IBM eServer zServer system for example.

The gateway computer 206 may also be coupled to a storage device (such as data repository). Further, the gateway 206 may be directly or indirectly coupled to one or more workstations 101 such as clients 1-4 201-204 as shown.

Those skilled in the art will appreciate that the gateway computer 206 may be located a great geographic distance from the network, and similarly, the workstations 101 may be located a substantial distance from the networks. For example, the network may be located in California, while the gateway 206 may be located in Texas, and one or more of the workstations 101 may be located in New York. The workstations 101 may connect to the wireless network using a networking protocol such as the Transmission Control Protocol/Internet Protocol (“TCP/IP”) over a number of alternative connection media, such as cellular phone 203, radio frequency networks, satellite networks, etc. The wireless network preferably connects to the gateway 206 using a network connection such as TCP or UDP (User Datagram Protocol) over IP, X.25, Frame Relay, ISDN (Integrated Services Digital Network), PSTN (Public Switched Telephone Network), etc. The workstations 201-204 may alternatively connect directly to the gateway 206 using dial connections. Further, the wireless network and wired network may connect to one or more other networks, in an analogous manner to that depicted in FIG. 2.

Software programming code which embodies the present invention is typically accessed by the microprocessor 106 of the workstation 101 (clients 1-5 201-205) or server 206 from long-term storage media 107, such as a CD-ROM drive or hard drive. The software programming code may be embodied on any of a variety of known media for use with a data processing system, such as a diskette, hard drive, or CD-ROM. The code may be distributed on such media, or may be distributed to users from the memory or storage of one computer system over a network to other computer systems for use by users of such other systems.

Alternatively, the programming code 111 may be embodied in the memory 105, and accessed by the microprocessor 106 using the processor bus. Such programming code includes an operating system which controls the function and interaction of the various computer components and one or more application programs. Program code is normally paged from dense storage media 107 to high speed memory 105 where it is available for processing by the processor 106. The techniques and methods for embodying software programming code in memory, on physical media, and/or distributing software code via networks are well known and will not be further discussed herein.

A user of the present invention may connect his computer to a server using a wireline connection, or a wireless connection. Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The user's computer may be any type of computer processor, including laptop, handheld or mobile computers; vehicle-mounted devices; desktop computers; mainframe computers; etc., having processing and communication capabilities. The remote server, similarly, can be one of any number of different types of computers which have processing and communication capabilities. These techniques are well known in the art, and the hardware devices and software which enable their use are readily available. Hereinafter, the user's computer will be referred to equivalently as a “workstation”, “device”, or “computer”, and use of any of these terms or the term “server” refers to any of the types of computing devices described above.

In a preferred embodiment, the present invention includes one or more computer software programs 111. The implementation of the software of the present invention may operate on a user's workstation, as one or more modules or applications 111 (also referred to as code subroutines, or “objects” in object-oriented programming) which are invoked upon request. Alternatively, the software may operate on a server in a network, or in any device capable of executing the program code implementing the present invention. The logic implementing this invention may be integrated within the code of an application program, or it may be implemented as one or more separate utility modules which are invoked by that application, without deviating from the inventive concepts disclosed herein. The application 111 may be executing in a Web environment, where a Web server provides services in response to requests from a client connected through the Internet. In another embodiment, the application may be executing in a corporate intranet or extranet, or in any other network environment. Configurations for the environment include a client/server network, Peer-to-Peer networks (wherein clients interact directly by performing both client and server function) as well as a multi-tier environment. These environments and configurations are well known in the art.

In the process of searching databases, the efficiency of finding objects depends not only on the information system structure (such as database schema, and searchable fields), but also depends on additional factors that need to be taken into consideration. These factors include for example:

1) uniqueness and value distribution of the searchable attributes;

2) the knowledge of end-users about the searchable fields; and

3) the previous inputs from the end-users if available.

Objects to be searched have attributes. For example, information about a house in a real estate listing comprise the attributes of the house “object”. Such attributes might include geography (address, county, state), price, house style (such as colonial, ranch, etc.) and the like.

In this invention, we define the knowledge of the end-users about the value of an attribute (i.e. what the end-user knows about the value of an attribute) as the searchability of that attribute, which will be discovered by the system through the usage of the system.

An adaptive search is a dynamic process between the end-user and the system. There is a feedback between the back end system (the back end system includes the application program performing the search) and the end-user. The back end system will compute the search field(s) and create search question(s) based on the previous inputs from the end-user.

Definitions:

“Set of Attributes”: the set of attributes, each attribute could have zero to many attribute values associated with it.

“Set of Searchable Attributes”: the sub-set of “Set of Attributes” that end-user is allowed to search on.

“Searchable Attribute Label”: a user friendly indication of a Searchable Attribute. Labels include text, graphic, audio, video or other representations of a Searchable Attribute.

“Ordered Attributes”: presentation of attributes to the user such that Attributes are presented in an “order” that is an indication of the potential success of using the attribute. The attributes may be ordered by text listing, by highlighting, by presentation sequence or by representative icons for example.

“Set of Concise Attributes”: the sub-set of “Set of Attributes” that enable an end-user to distinguish different objects.

“Changeable Set of Searchable Attributes”: the sub-set of “Set of Searchable Attributes”. It's equal to the Set of Searchable Attributes as the search starts; during the search process, each time the user selects an attribute and provides the value, the attribute is then excluded from this set.

“Searchability”: an integer between 0 and 1 that represents the possibility that the end-users in general know about the searchable attribute value when they use the system. The default value of searchability for an attribute is 1. The system is designed to have a mechanism to store and dynamically adjust the searchability values in the process of system being used.

A “deduced attribute”: a new attribute whose value is a deduced from one or more other attributes.

A “deduced system”: a subset of the original information system. Preferably, the deduced system is created based on the inputs of the end-user.

A “value space” for an attribute: the set of all possible values that the attribute can have. The value for an attribute is defined as a primitive variable. A primitive variable could be: 1) ASCII or Unicode String, 2) real number; 3) integer; and 4) natural number (zero and positive integer).

“Entropy” of an attribute: A function of the value distribution for that attribute in a given system.

“AdjustedEntropy”: the product of the searchability and the entropy of a given attribute of the original information system or “deduced system”.

“Cardinality”: the number of selectable values for an attribute of the original information system or “deduced system”. The cardinality of an attribute will be one of the three selections:

a) The cardinality is a positive integer. Example is the age of people, we can be quite sure to say that the cardinality is 200 or even less.

b) The cardinality is the same as the cardinality of all integers. Example is that the distance from a vehicle location to a restaurant in miles. It is well-known that the cardinality of all the integers is same as the cardinality of non-negative integers from the set theory.

c) The cardinality is the same as the cardinality of all real numbers; example is that the weight of a person.

“Default Adjusted Entropy”: the adjusted entropy for the original information system.

“Minimum Threshold”: a positive integer that determines when the search will be stopped. During the search process, when the number of objects in the “deduced system” is less than or equal to this number, the system will stop the search process with a limited number of objects returned to the user. The user has the option to view the details of the attributes of each object and select the desired one.

“Maximum Threshold”: a positive integer, larger than the minimum threshold. If the number of the search results is larger than this number, the system will use the default-adjusted entropy as its adjusted entropy value to compute and order search attribute(s) to reduce the computation time.

A “search”: a series of interactions between the back end system and an end-user to help him/her to find the desired objects.

Search Procedure

The search process will proceed as follows:

1. The system initiates the search by gathering the initial Changeable Set of Searchable Attributes.

2. The system reorders the Changeable Set of Searchable Attributes based on the Default Adjust Entropy and presents to the user, this set of attributes as questionnaire (or prompting information). The attributes are represented by attribute labels.

3. The user indicates his preference by selecting one attribute from the questionnaire (The user may optionally elect a boolean operator for the attribute such as and, or, not and the like).

4. The system asks the user to enter the value of that attribute either through a keyboard, by voice, by PDA, by message window, or some other modality.

5. The system will use the answer to filter the system and create the deduced system based on the input by filtering out the objects that do not satisfy the inputs.

6. The system will find the number of the return results in the deduced system. If the number of results is larger than a pre defined maximum threshold. Go to step 2.

7. The system will adjust the Changeable Set of Searchable Attributes by excluding the one that has been searched from subsequent questionnaires.

8. Reorder and render the questionnaires based on the adjusted entropy calculation of the deduced system.

9. Repeat steps of 3-6 until the number of the result object is less than the minimum threshold; Or the user gives up; Or all the searchable attributes have been exhausted;

10. If there is more than one returned result; display the objects with values of their Concise Attributes;

11. End-user will select one of the objects and the user can retrieve any attribute value(s) for any attribute.

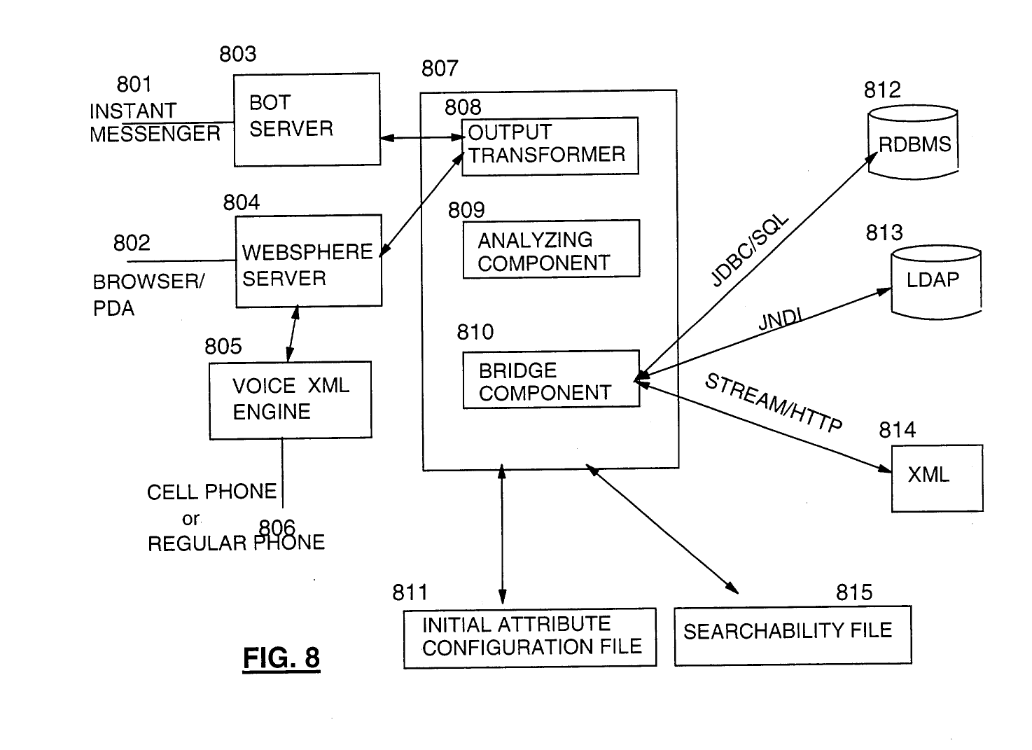

The present invention comprises preferably a three-tier architecture FIG. 8. As an example, at the user-end, the communication media is any one of a web browser 802, a cellular or regular phone 806, a PDA device 806, or a messaging window 801. The back end is any information system, which stores the information of the objects including a DB2 Relational database. The middle tier comprises our invention 807. This tier consists of the following four components:

1) The Server-adaptor layer 803-805 is used to plug the search system into middleware system. The two implemented adapters are the Servlet and Bot.

2) The Transformation Component 808, which transforms the XML by applying an XSL transformation into VXML/WML/HTML/Text based on the device being used.

3) The Analyzing Component 809, which calculates the randomness for each attribute and determines the next set of questionnaire to prompt the user based on the searchability and adjusted entropy.

4) The Bridge Component 810, which connects to a back end repository to find out the qualified objects and the corresponding meta-information. The back end system could be RDBMS 812, LDAP 813 or XML 814 for example.

The implementation architecture is application independent, which means that the application specific information is externalized into external property files. Furthermore, the specification of information format for each supported communication devices is also externalized. The externalized information is preferably organized using XML technology. Table 1 is an example initialization file.

The searchability is serialized out (saved) periodically into the file system to protect the data due to the possible system failure (such as server crash or power outage).

An example procedure to enable a search based on the techniques of this invention is as follows:

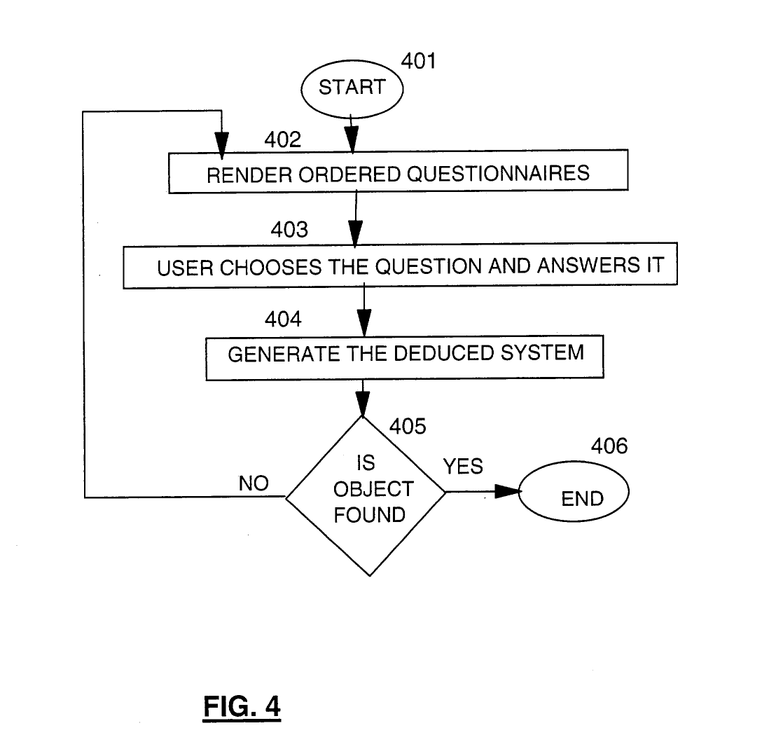

Create deduced attributes if needed FIG. 4. As defined above, a deduced attribute is a new attribute which value is a map from one or more other attributes. Often, users prefer not to search on the original attribute(s) but the deduced attribute(s). An example in the realty industry is that agents and buyers like to search the house(s) based on the price range rather than the price itself.

The steps involved are:

1. Define the searchability for every attribute. Searchability represents the probability of end-users knowing the attribute value when they are searching for objects. For example, MLS (Multiple Listings Number) is a number of a house selling in the market. But for a regular buyer, the searchability of the MLS number could be very low. The buyer knows the number only if he/she visited house or searched the house(s) based on other search attributes.

2. Find cardinality and uniqueness of allowed values for each attribute. If a value from the value space of an attribute can only appear once for an information system, we define the attribute as having the uniqueness property. If the data in the back end is stored inside relational database, the attributes (columns) defined as primary keys or unique have the uniqueness properties.

3. Design the interactive method for each attribute. For an attribute that has an integer as its cardinality, that means there are only limited values for a possible selection. To increase the search-ability in one preferred implementation, an interactive interface is provided, which allows the end-user to make a selection from a list of the possible values. If the cardinality of attribute is same as the cardinality of integer or real value, the user is prompted explicitly enter or say the value of the attribute.

4. Calculate the entropy and adjusted-entropy values for each attribute. Since a database or any other store system such as LDAP can only save limited objects, the entropy is calculate for limited value space. For a given attribute that does not have the uniqueness property, it is assumed that there are N different values; the total number of objects is M. The frequency of each value is pᵢ. Let s be the search-ability of the attribute, then the adjusted entropy can be calculated as:

$$e = - M \times s \times {\sum }_{i = 1}^{N} {p}_{i} \times ln {p}_{i} where {\sum }_{i = 1}^{i = N} {p}_{i} = 1$$

For those attributes having the uniqueness properties, the value of the adjusted entropy is:

e=M*s*lnM

5. Selection of the candidate attribute based on 3. and 5. The candidate will be selected based on the following principles:

a. The attributes will be sorted based on the adjusted entropy; select the attribute that has the maximal adjusted entropy value;

b. If two of the attributes have same adjusted entropy, choose the one that has the uniqueness property; or the one that has a smaller cardinality;

c. If we still cannot make selection after step a. and b., randomly select one with equal chance.

6. Record the inputs from the end-users. Logically, searchability is a piece of information related to the end-user. The system does not have the knowledge of which attribute that end-users know better at the beginning. The system can eventually gain the knowledge through the usage of the system by the end-users. For example, to store the usage information, in one embodiment, the user selects a specific answer. If an end-user does not know a value of attribute, he/she can enter “do not know” for the given attribute. This information will also be recorded and used for automatically adjusting searchability value for this attribute by the server along with other information.

7. Adjust searchability values. An adjustment factor “α” is a real number from 0 to 1 for a given attribute, which will be used to adjust the searchability value. The value of the factor will determine how adaptive of the attribute to the usage of system. If we let to be 0, then the searchability will not be sensitive to the answer from the user.

Two ways of adjusting the searchability based on the usage of the system comprise:

The end-user will enter “unknown” explicitly for an attribute.

The end-user will only answer the question if they know the answer.

For the first case, we assume that “does not know” is a legitimate answer. Let us assume that the searchability for an attribute is s₀ before the search, after one step of the search process, the new searchability s₁ will be changed into:

a. s₁=s₀, if the attribute is not used for the search;

b. s₁=(1−α)s₀+α, if the attribute is searched on, and the user knows how to enter the value;

C. s₁=(1−α)s₀, if the attribute is searched on, and the user says that he/she does not know how to enter the value.

For the case that “does not know” is not a legitimate answer, we need to have another way of calculating the search-ability.

a. Assume there are k attributes, and let N be the total number of the accomplished search sessions; N₁, N₂, . . . , Nₖ are the total numbers of the searchable attributes being used for search.

Let

F₁, F₂, . . . , Fₖ are the frequency of the attribute being used, and defined as

$${F}_{i} = \frac{{N}_{i}}{N}$$

b. Let we have a new search session;

c. Let s₀ be the initial search-ability for an attribute before the search session;

d. Let α be a small predetermined positive constant (0<α<1). At the end of the search session:

s₁=(1−α)s₀+α*Fᵢ if i-th attribute is used.

e. Re-compute N₁, N₂, . . . , Nₖ and F₁, F₂, . . . , F_{N} after a search session.

Furthermore, if the end-users can be categorized into multiple groups, and the system can identify the group of the end-user. The system can define multiple sets of search-ability whereby each user group can have its own set of search-abilities.

Employee Directory Adaptive Search Application Example:

An end-user wants to find the detailed information of an employee based on limited or fuzzy knowledge about the employee. Let us assume that the back end is an LDAP directory 813 where each user has an entry with multiple attributes and their values. An example implementation supports a user searching employee information through bot, voice, PDA and web browsers using the adaptive search technology.

The end-user usually knows which employee he is looking for, that is the user has the ability of identifying the employee information from an employee list, if there is enough information given for each employee on the list.

In a preferred embodiment uses Java and XML technologies. Each search process is defined as a session object at the run-time engine. The session has the memory of the previous inputs from the end-user. The session will send the query to the back end LDAP system 813. The result of each search are sent to an analyzing program 809 to compute the adjusted entropy of each unused attribute. XML is used internally as the data exchange format between the back end system and running-time engine and as the format for rendering the output format for the end-user.

Based on how the user selects the attribute to enter the search attribute values, the analyzing program will update the searchability (learn the searchability). The searchability will be saved to the file system for every predetermined number of searches.

The output formats will be separated into two categories: Text and XML based. The text based output will be used for an output device that only accepts plain text input and output. Examples of such device are SAMETIME from LOTUS, or Instant Message from AOL.

Using the XML based format, support of specific communication device can be reduced as supporting a specific XML format. Device-specific XSL files are used for rendering the questionnaire for selection of an attribute, presenting the results of a search and presenting a specific question for an attribute. Some output devices supported by XML based output format include web browser using HTML format, PDA using WML format and phone using VXML.

At the back end, a specific adapter will create XML output by locating all the employee information found from the LDAP server and returning the information to the session.

TABLE 1

```
<?xml version=“1.0”?>
<adaptivesearch lowest=“3” highest=“100” adaptivefactor=“0.9”
searchabilityupdate=“1” defaultdevice=“vxml”>
  <attribute name=“lastname” option=“1”>
    <attributetype>letter</attributetype>
    <vxml>
      <optioninfo>Last name</optioninfo>
            <question>Spell the last name of the
person</question>
      <grammar>( A | B | C | D | E | F | G | H | I | J | K
| L | M | N | O | P | Q | R | S | T | U | V | W | X | Y | Z
)+</grammar>
      <catch event=“noinput nomatch”>
        <reprompt/>
      </catch>
    </vxml>
    <wml>
      <optioninfo>Last name</optioninfo>
      <question>Enter last name</question> </wml>
  </attribute>
  <attribute name=“firstname” option=“2”>
    <attributetype>letter</attributetype>
    <vxml>
      <optioninfo>First name</optioninfo>
      <question>Spell the first name of the
person</question>
      <grammar>( A | B | C | D | E | F | G | H | I | J | K
| L | M | N | O
  | P | Q | R | S | T | U | V | W | X | Y | Z )+</grammar>
      <catch event=“noinput nomatch”>
        <reprompt/>
      </catch>
    </vxml>
    <wml>
      <optioninfo>First name</optioninfo>
      <question>Enter first name</question>
    </wml>
  </attribute>
  <attribute name=“telephone” option=“3”>
    <attributetype>digits</attributetype>
    <vxml>
      <optioninfo>telephone number</optioninfo>
      <question>Spell or punch one to eleven digit
telephone
    number clearly and loudly</question>
      <grammar
src=“builtin:grammar/digits?minlength=1;maxlength=11”
mode=“dtmf”></grammar>
      <catch event=“noinput nomatch”>
        <reprompt/>
      </catch>
    </vxml>
    <wml>
      <optioninfo>Telephone number</optioninfo>
      <question>Enter Telephone Number</question>
    </wml>
  </attribute>
</adaptivesearch>
```

Referring to FIG. 4, an example flow of the invention is shown. The system renders an ordered questionnaire 402 to the user. The user chooses a question and answers it 403. The system uses the answer to deduce a search object 404. If the object is found, the system goes on to the next phase 406.

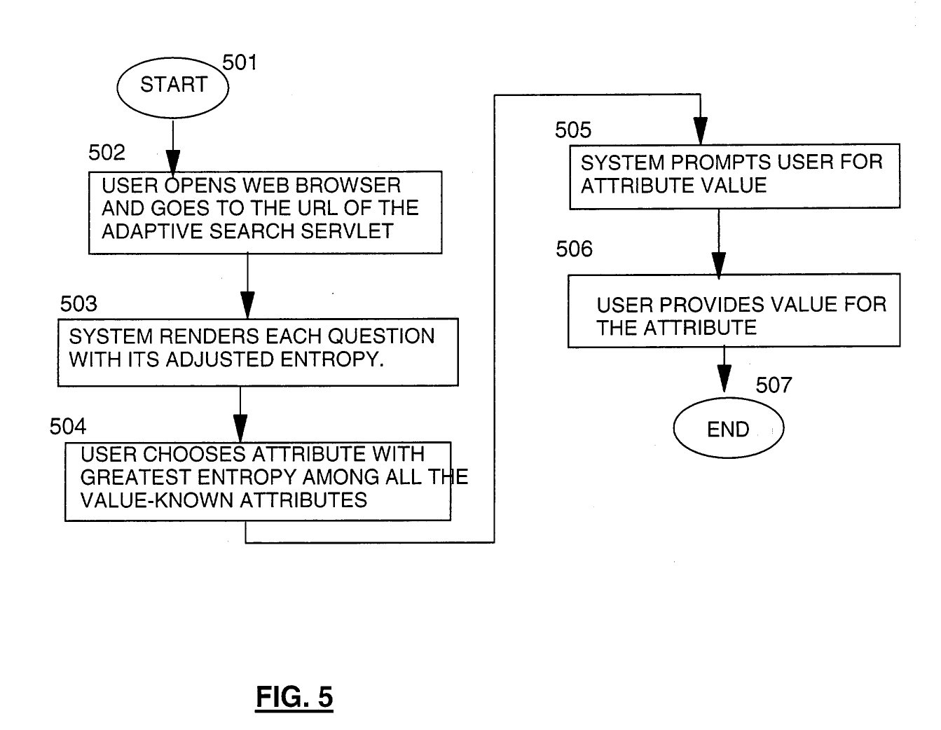

FIG. 5 depicts a flow of a representative system using a web browser. A user opens a web browser and enters a URL of an adaptive search screen (servlet) 502 for finding a person. The system provides the user with questions having adjusted entropy 503 (Searchable attribute labels Name, Address, Social Security Number for example). The user chooses an attribute label that represents a searchable attribute for which he knows the value (Search-ability) and which has the greatest entropy 504 (Name for example). The system prompts the user for a value for the attribute 505. The user provides the value (“William Tell” for example) for the attribute (Name) 506.

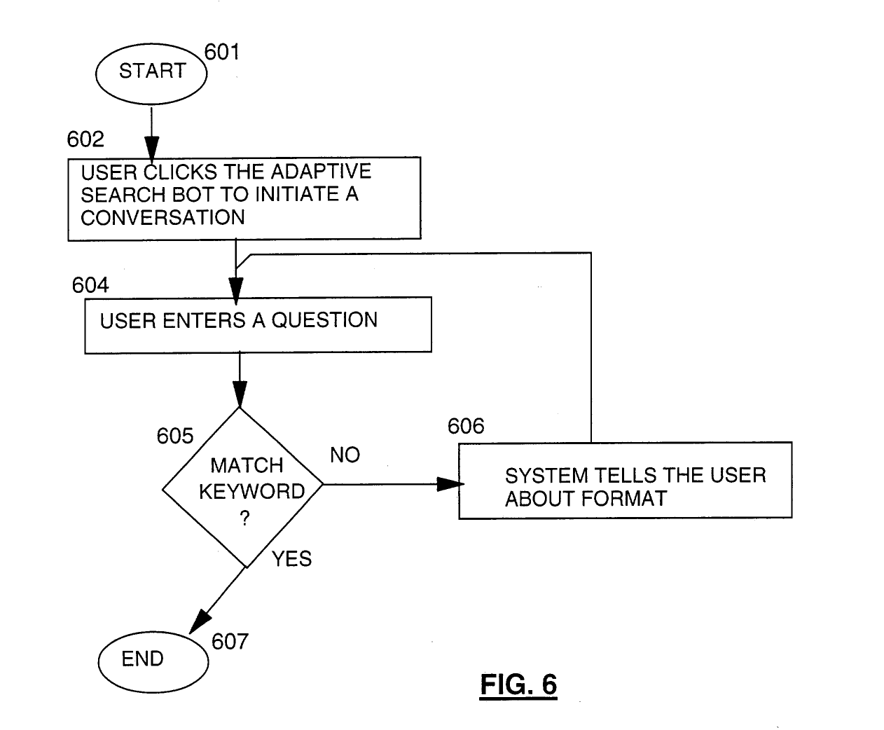

FIG. 6 depicts a flow of a representative system using an instant message bot. A user clicks on an adaptive search instant message bot to initiate a conversation with the search bot 602. The user enters a question (who is JOHN SMITH) 604. If the system understands the question, the search is begun 607, if not, the system prompts the user to describe the accepted format 606.

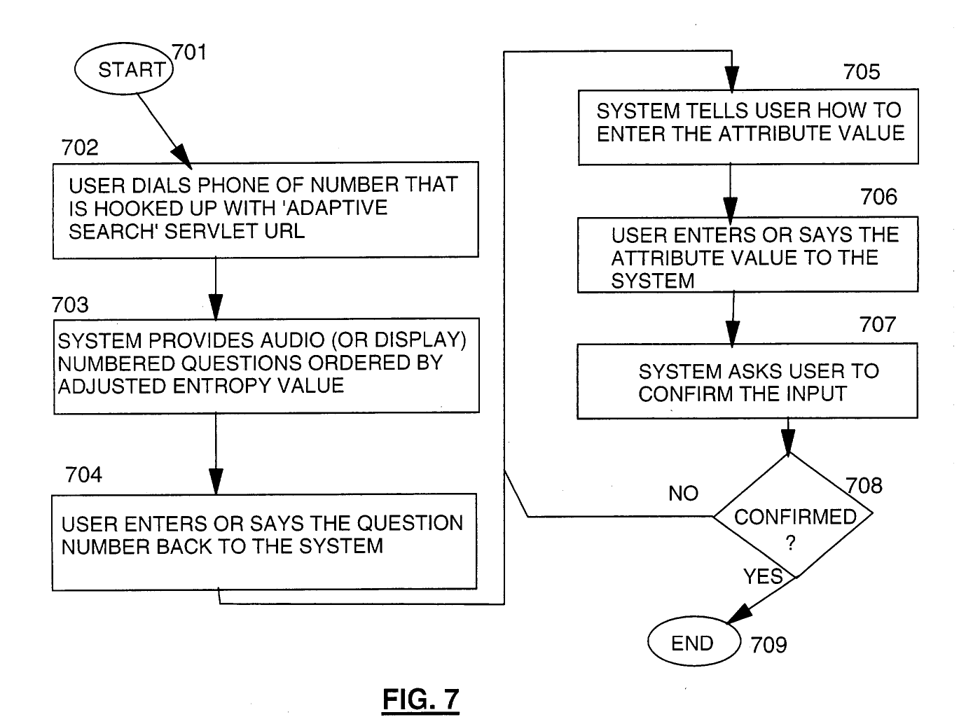

FIG. 7 depicts a flow of a representative system using a phone. A user dials the phone number that has been hooked up with the URL of an Adaptive Search servlet 702. The system reads out questions without its entropy. Questions are ordered by the attribute's adjusted entropy value 703 (1 Department, 2 Employee . . . ). The user enters or says the numerical number (2) assigned to a question (Employee) 704. The system tells the user how to enter the value of an attribute (say last name) 705. The user uses phone keypad or phone speaker to enter or speak the attribute value to the system (Smith) 706. The system asks the user to confirm the input (say yes) 707. If 708 the user confirms the value, the system continues to the next phase 709, otherwise the user is prompted again 705.

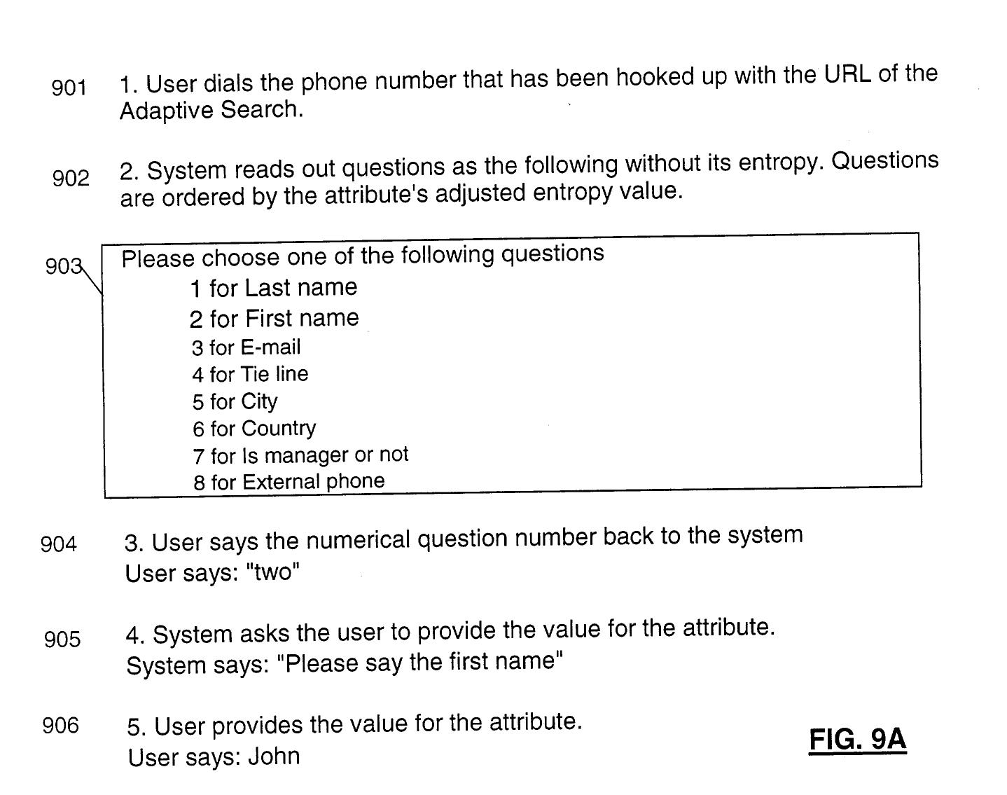

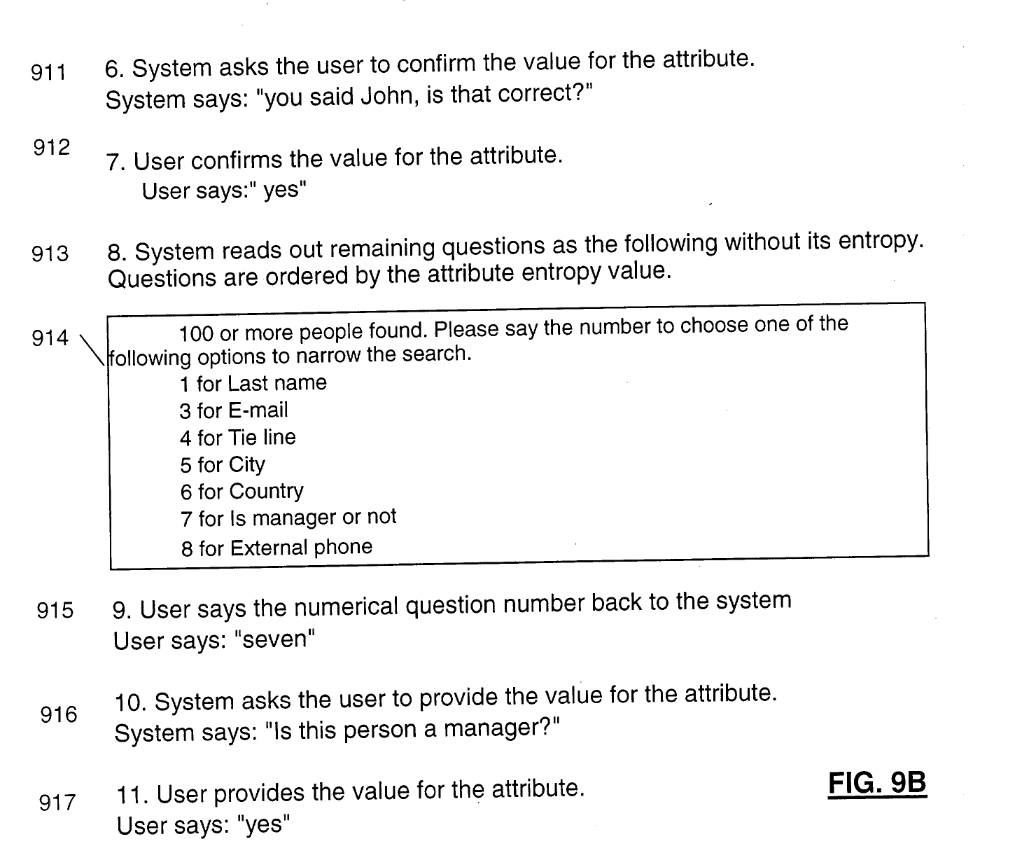

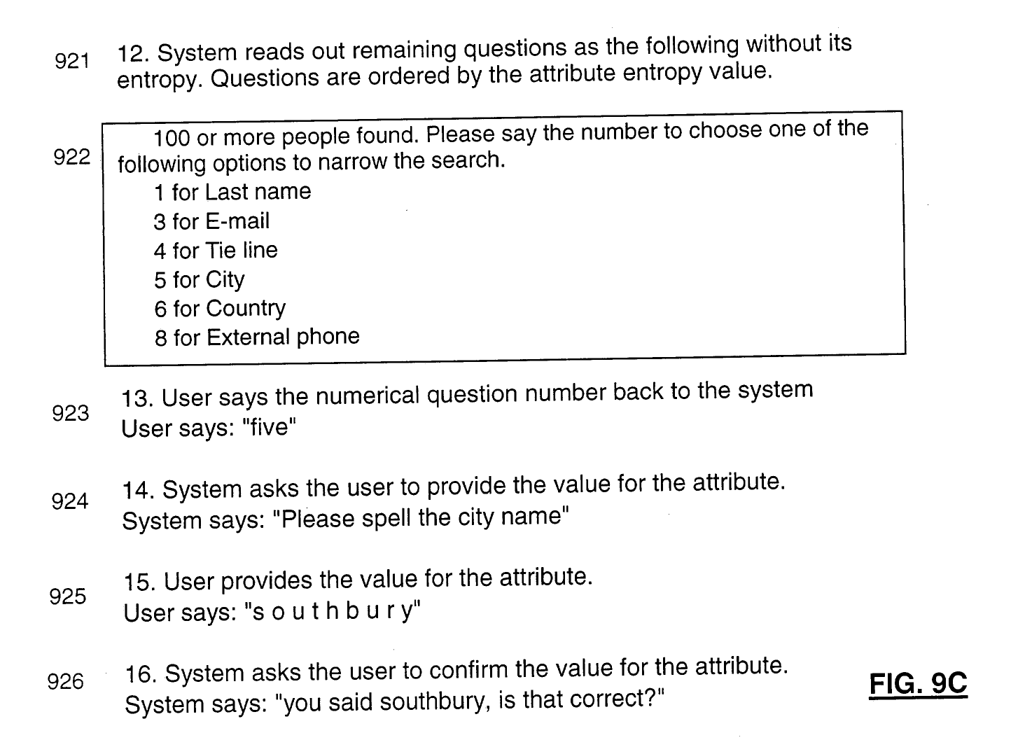

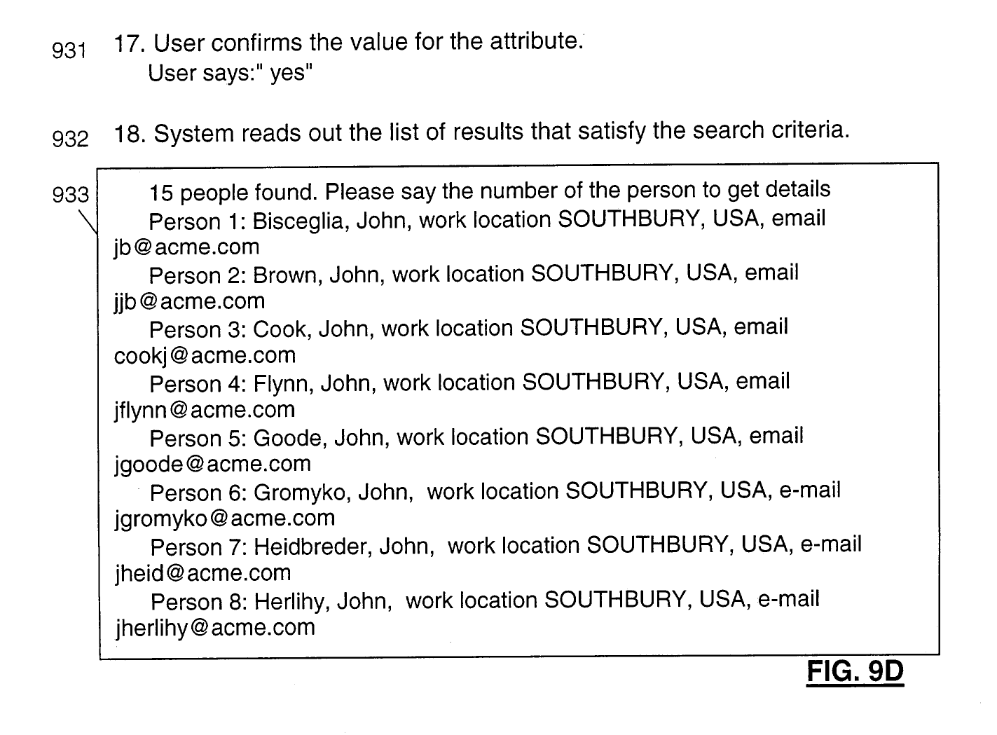

In another example of the invention having a user connected by phone FIG. 9A-9D, the user dials the phone number of an application that communicates with an adaptive search engine 901. The system reads out questions without entropy ordered by attribute entropy value 902. The readout 903 explains that “100 or more people found, please say the number to choose one of the following options to narrow the search”. This is followed by a numbered set of attributes 1-8. The user says the number of the attribute back to the system “two” 904. The system asks the user to provide the value for the Attribute 905 by saying “Please say the first name” 905. The user provides the value for the attribute by answering “John” 906. The system asks the user to confirm the value for the attribute by saying “you the John, is that correct?” 911. The user responds “yes” 912. The system reads out the remaining questions without entropy ordered by Attribute entropy value 913. This is followed by a numbered set of attributes 1-8 with Attribute 2 omitted. The user says the number of the attribute back to the system “seven” 915. The system asks the user to provide the value for the Attribute 916 by asking the question associated with the number provided by the user “Is the person a manager?” 916. The user provides the value for the attribute by answering “yes” 917. The system reads out the remaining questions without entropy ordered by Attribute entropy value 921. The system says “100 or more people found. Please say the number to choose one of the following options to narrow the search” 922. This indicates to the user that the low number needed to automatically display results has not yet been matched. The list of Attributes is provided 1-8 with Attributes 2 and 7 omitted 911 as they have already been used. The user says the numerical value of the attribute back to the system “five” 923. The system asks the user to provide the value for the attribute by saying “Please spell the city name” 924. The user provides the value for the attribute by saying the letters “southbury” 925. The system asks the user to confirm the value for the attribute by saying “you the southbury, is that correct?” 926. The user responds “yes” 921. The system responds “15 people found. Please say the number of the person to get details” 933. The system then lists the objects found (in one implementation, each person is listed in response to a prompt for “next”. In another implementation a sublist of groups of 8 people are listed at a time.)

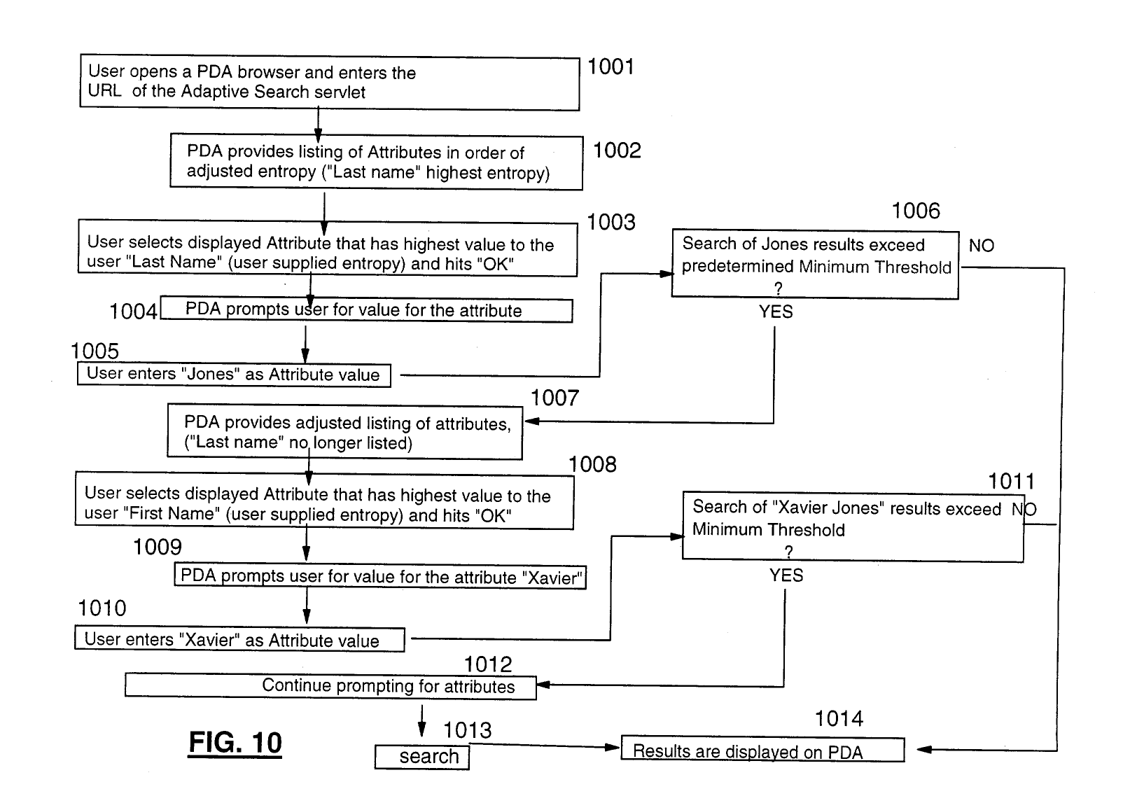

In another example of the invention FIG. 10, the user opens a PDA browser and enters the URL of the Adaptive Search engine servlet 1001. The PDA displays a listing of attributes in order of adjusted entropy (i.e. “Last Name” highest entropy)

1002. The user selects a displayed Attribute that has the highest value to the user (“Last Name”) and hits “OK” 1003. The PDA prompts the user for a value for the attribute 1004. The user enters an attribute value (“Jones”) 1005. The system determines if the results are less than a predetermined Minimum Threshold 1006, if so, the results are displayed on the PDA 1014, otherwise, the PDA adjusts the list of attributes removing the one that has already been selected and present the new list to the user 1007. The user selects the displayed Attribute that has the highest adjusted entropy value to the user “First Name” from the attribute list and hits “OK” 1008. The PDA prompts the user for a value for the attribute 1009. The user enters the value for the Attribute (“Xavier”) 1010. The system determines if the results of the selected attributes result in a number of objects that is less than the Minimum Threshold 1011. If so, the results are displayed on the PDA 1014, if not, the system continues prompting the user the remaining attributes 1012 and the user will go through the search feed backs 1013 again.

The present invention reduces the cost of searching, (here cost is defined as the number of question/response pairs needed to arrive at a search object). The invention demonstrates a method for analyzing an information system based on the entropy calculation of searchable attributes, determining an order of searchable attributes, tracking user inputs and ordering the attributes based on user inputs being tracked.

Entropy calculation is preferably based on the value distribution of the attribute, its cardinality and its uniqueness properties.

Determining the ordering of the searchable attributes is preferably based on adjusted entropy.

Calculating the adjusted entropy is preferably based on the intrinsic entropy of deduced system and the searchability values of search attributes. The searchability is preferably determined based on the knowledge of end users of the value domain of that attribute and by the user inputs.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A method for performing an adaptive search of a data repository, the method comprising the steps of:
determining a first searchable attribute of entries in the data repository;
determining a second searchable attribute of entries in the data repository;
deducing first prompting information for requesting user preferences, the first prompting information comprising ordered first and second searchable attribute labels;
providing the first prompting information to a user;
receiving a first user preference for searching the data repository using the first searchable attribute, the first user preference comprising a first value;
first searching data repository entries according to the first user preference, the first searching producing a first deduced system of data repository entries;
deducing second prompting information for requesting user preferences, the second prompting information comprising reordered first prompting information, the second prompting information comprising the second searchable attribute label;
providing the second prompting information to the user;
receiving a second user preference for searching the data repository using the second searchable attribute, the second user preference comprising a second value;
second searching data repository entries according to the first and second user preferences; and
providing to the user, data repository result information obtained by the second searching step.

2. The method according to claim 1 wherein any one of the first or second prompting information comprises an ordered list of attributes.

3. The method according to claim 1 wherein any one of the first or second user preference comprises a boolean operation, the boolean operation relating the second searchable attribute to the first searchable attribute, the boolean operation comprising any one of AND, OR or NOT.

4. The method according to claim 1 wherein the deducing second prompting information step reorders searchable attributes from the first prompting information based on the first user preference.

5. The method according to claim 1 wherein the deducing second prompting information step comprises eliminating the first searchable attribute.

6. The method according to claim 1 comprising the further steps of:
saving information from any one of the first or second user preference in a user preference history information storage; and
determining a search-ability value for any one of the first or second searchable attribute using the saved user preference history information.

7. The method according to claim 1 wherein ordering searchable attributes in the second prompting information depends on a search-ability value.

8. The method according to claim 1 wherein ordering searchable attributes in the second prompting information depends on an entropy value.

9. The method according to claim 8 wherein a default entropy value is used when the second searching step results in a quantity of result information that is greater than a predetermined number.

10. The method according to claim 1 wherein the first prompting information comprises a message to the user, the message requesting that the user enter a value of a searchable attribute.

11. The method according to claim 1 wherein the second searching step comprises filtering entries resulting from the first searching step using the second value.

12. The method according to claim 1 wherein the second prompting information comprises an indication of a quantity of entries resulting from the first searching step.

13. The method according to claim 1 wherein the user interface comprises any one of a web browser, a mobile phone, a PDA, a telephone or a messaging window by way of any one of audio, video, digital signal, analog signal, wireless communication, voice to text or text to voice.

14. The method according to claim 1 wherein any one of the first value or the second value comprises any one of a name of a person, an address, a title of a person, an attribute of a person, a name of an object, a location of an object or an attribute of an object.

15. The method according to claim 1 wherein the providing to the user data repository result information step is performed when the quantity of information is less than a predetermined number.

16. The method according to claim 1 wherein the providing to the user data repository result information step is performed when a request is received for providing result information.

17. The method according to claim 7 wherein the search-ability value is determined by any one of a measure of the usage of the attribute by one group of two or more groups of users, a measure of the usage of the attribute by all users, a measure of the usage of the attribute by a user's location, a measure of the usage of a sample of users, a measure of the frequency of use or a measure of the usage of polled users.

18. The method according to claim 8 wherein the entropy value is determined by any one of the randomness of the attribute distribution, the distinguish-ability of the attribute or the frequency of occurrences of values in the attribute.

19. A computer program product for performing an adaptive search of a data repository, the computer program product comprising a computer readable medium having computer readable program code therein comprising:
computer readable program code for determining a first searchable attribute of entries in the data repository;
computer readable program code for determining a second searchable attribute of entries in the data repository;
computer readable program code for deducing first prompting information for requesting user preferences, the first prompting information comprising ordered first and second searchable attribute labels;
computer readable program code for providing the first prompting information to a user;
computer readable program code for receiving a first user preference for searching the data repository using the first searchable attribute, the first user preference comprising a first value;
computer readable program code for first searching data repository entries according to the first user preference, the first searching producing a first deduced system of data repository entries;
computer readable program code for deducing second prompting information for requesting user preferences, the second prompting information comprising reordered first prompting information, the second prompting information comprising the second searchable attribute label;
computer readable program code for providing the second prompting information to the user;
computer readable program code for receiving a second user preference for searching the data repository using the second searchable attribute, the second user preference comprising a second value;
computer readable program code for second searching data repository entries according to the first and second user preferences; and
computer readable program code for providing to the user, data repository result information obtained by the second searching step.

20. The computer program product according to claim 19 wherein any one of the first or second prompting information comprises an ordered list of attributes.

21. The computer program product according to claim 19 wherein any one of the first or second user preference comprises a boolean operation, the boolean operation relating the second searchable attribute to the first searchable attribute, the boolean operation comprising any one of AND, OR or NOT.

22. The computer program product d according to claim 19 wherein the computer readable program code for deducing second prompting information reorders searchable attributes from the first prompting information based on the first user preference.

23. The computer program product according to claim 19 wherein the computer readable program code for deducing second prompting information comprises eliminating the first searchable attribute.

24. The computer program product according to claim 19 further comprising:
computer readable program code for saving information from any one of the first or second user preference in a user preference history information storage; and
computer readable program code for determining a search-ability value for any one of the first or second searchable attribute using the saved user preference history information.

25. The computer program product according to claim 19 wherein ordering searchable attributes in the second prompting information depends on a search-ability value.

26. The computer program product according to claim 19 wherein ordering searchable attributes in the second prompting information depends on an entropy value.

27. The computer program product according to claim 26 wherein a default entropy value is used when the computer readable program code for second searching results in a quantity of result information that is greater than a predetermined number.

28. The computer program product according to claim 19 wherein the first prompting information comprises a message to the user, the message requesting that the user enter a value of a searchable attribute.

29. The computer program product according to claim 19 wherein the computer readable program code for second searching comprises filtering entries resulting from the computer readable program code for first searching using the second value.

30. The computer program product according to claim 19 wherein the computer readable program code for second prompting information comprises an indication of a quantity of entries resulting from the computer readable program code for first searching.

31. The computer program product according to claim 19 wherein the user interface comprises any one of a web browser, a mobile phone, a PDA, a telephone or a messaging window by way of any one of audio, video, digital signal, analog signal, wireless communication, voice to text or text to voice.

32. The computer program product according to claim 19 wherein any one of the first value or the second value comprises any one of a name of a person, an address, a title of a person, an attribute of a person, a name of an object, a location of an object or an attribute of an object.

33. The computer program product according to claim 19 wherein the computer readable program code for providing to the user data repository result information is performed when the quantity of information is less than a predetermined number.

34. The computer program product according to claim 19 wherein the computer readable program code for providing to the user data repository result information is performed when a request is received for providing result information.

35. The computer program product according to claim 25 wherein the search-ability value is determined by any one of a measure of the usage of the attribute by one of two or more groups of users, a measure of the usage of the attribute by all users, a measure of the usage of the attribute by a user's location, a measure of the usage of a sample of users, a measure of the frequency of use or a measure of the usage of polled users.

36. The computer program product according to claim 26 wherein the entropy value is determined by any one of the randomness of the attribute distribution, the distinguish-ability of the attribute or the frequency of occurrences of values in the attribute.

37. An system for performing an adaptive search, the system comprising:
a first determiner determining a first searchable attribute of entries in a data repository;
a second determiner determining a second searchable attribute of entries in the data repository;
a first deducer deducing first prompting information for requesting user preferences, the first prompting information comprising ordered first and second searchable attribute labels;
a provider providing the first prompting information to a user;
a receiver receiving a first user preference for searching the data repository using the first searchable attribute, the first user preference comprising a first value;
a first searcher first searching data repository entries according to the first user preference, the first searching producing a first deduced system of data repository entries;
a second deducer deducing second prompting information for requesting user preferences, the second prompting information comprising reordered first prompting information, the second prompting information comprising the second searchable attribute label;
providing the second prompting information to the user;
receiving a second user preference for searching the data repository using the second searchable attribute, the second user preference comprising a second value;
second searching data repository entries according to the first and second user preferences; and
providing to the user, data repository result information obtained by the second searching step.

38. A method for performing an adaptive search of a data repository, the method comprising the steps of:
creating a first ordered list of searchable attributes;
presenting to a user a first displayable list comprising a first searchable attribute and a second searchable attribute;
receiving a response from the user, the response indicating a user elected first searchable attribute;
presenting to the user a second displayable list comprising the second searchable attribute, the list excluding user elected searchable attributes, the user elected searchable attributes comprising the first searchable attribute; and
performing a search of the data repository based on user elected searchable attributes.

39. The method for providing a user group restricted adaptive search interface for searching a data repository, the method comprising the steps of:
receiving a group identifier from a user;
beginning an adaptive search session;
determining limitations of data repository searches assigned th the group;
presenting in the session, an ordered list interface to the user, the ordered list comprising searchable attributes according to the limitations;
removing in the session, searchable attributes from the list as they are elected by the user; and
performing a search of the data repository based on user elected searchable attributes.
